(19) United States
(12) Patent Application Publication
(10) Pub. No.: US 2014/0352197 A1
(43) Pub. Date: Dec. 4, 2014

(54) FISHING DEVICE

(71) Applicants: Don Talbot, Wenatchee, WA (US); Jesse Brazill, East Wenatchee, WA (US)

(72) Inventors: Don Talbot, Wenatchee, WA (US); Jesse Brazill, East Wenatchee, WA (US)

(21) Appl. No.: 13/907,961

(22) Filed: Jun. 2, 2013

(51) Int. Cl. A01K 83/06

(52) U.S. Cl. CPC A01K 83/06
USPC 43/44.4

(57) ABSTRACT

The instant application discloses, among other things, a Fishing Device comprising a head with an openable portion which may be capable of holding a whole or part of a fish body, or other form of bait. Openable portion may comprise a gripping means, for example, teeth, for fixedly attaching the bait to the device. The first end of the head may be cut at an angle and may affect the spin motion or speed of the Fishing Device, for example, as it moves through water or any other medium.

### FIELD

This disclosure relates generally to a Fishing Device.

### BACKGROUND

Fishermen use various methods to lure and catch fish, often depending on the type of fish sought and its habitat. Common techniques include casting a rod, lowering a net, or rigging plug-cut bait such as herring, and trolling it through the water. Plug-cutting involves removing the head of the bait and attaching its body to a line and hook. The steepness of the angle at which the bait is cut affects its spin. The sight, movement, and scent of the moving bait help attract other fish. Unfortunately, the force from the movement and water pressure often causes the bait to tear and detach from the line and hook.

### SUMMARY

The instant application discloses, among other things, a Fishing Device comprising a head portion which may resemble the head of a fish, such as herring, or may simply be cut at a particular angle. The Fishing Device may have an openable portion with a gripping means, such as teeth, for fixedly attaching the bait to the device, for example, when the Fishing Device is moved through water or other medium. A person having skill in the art will recognize that other means besides teeth may be used to hold bait in place.

The openable portion may be held closed with a fastener, and may be coupled to the device body by a hinge. In one embodiment, the openable portion may be held fast with one or more fasteners. The Fishing Device may also provide a way to secure a fishing line, a hook or other means to secure the bait or other fishing devices. It may also have a wing to influence movement through water. One having skill in the art will recognize that the Fishing Device may be made in a various sizes to accommodate different size herring, anchovy, or other types of bait.

### BRIEF DESCRIPTION OF THE DRAWINGS

FIG. 1 illustrates a side view of Fishing Device with an Openable Portion according to one embodiment.

FIG. 2 illustrates the opposite side view of Fishing Device according to the first embodiment.

FIG. 3 illustrates an interior view of Openable Portion with Gripping Teeth.

FIG. 4 illustrates a side view of another embodiment.

### DETAILED DESCRIPTION

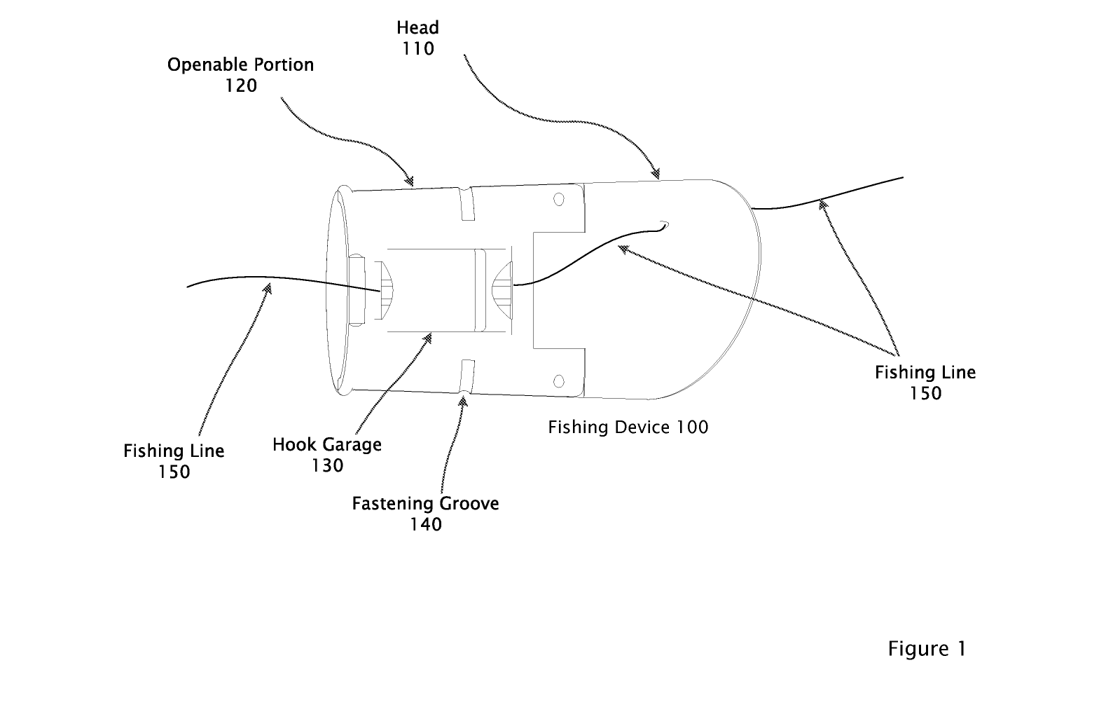

FIG. 1 illustrates a side view of Fishing Device 100 according to one embodiment. Fishing Device 100 may comprise a Head 110, which may generally resemble the head of a fish such as herring or anchovy, for example. Head 110 may also resemble a cut plug herring head, with a front Surface 330 at an angle which may cause Fishing Device to spin or spiral when pulled through water.

Head 110 may have an Openable Portion 120 which may be attached to Head 110 by Hinge 150, allowing Openable Portion 120 to open and allow the bait to be placed between Head 110 and Openable Portion 120.

A rubber band or other means, including but not limited to an O-ring, magnet, clip, or thread, may be placed over Fastening Groove 140 to secure Openable Portion 120 to Head 110. Openable Portion 120 may also have a Hook Garage 130 which may hold a shank of a hook, or may perform as a guide for a Fishing Line 150. It may also store a hook safely while Fishing Device 100 is not being used. Hook Garage 130 may also have a ridge, slit, or other means capable of receiving a rubber band, a piece of surgical tubing, and O-ring, or any other means for keeping Openable Portion 120 closed.

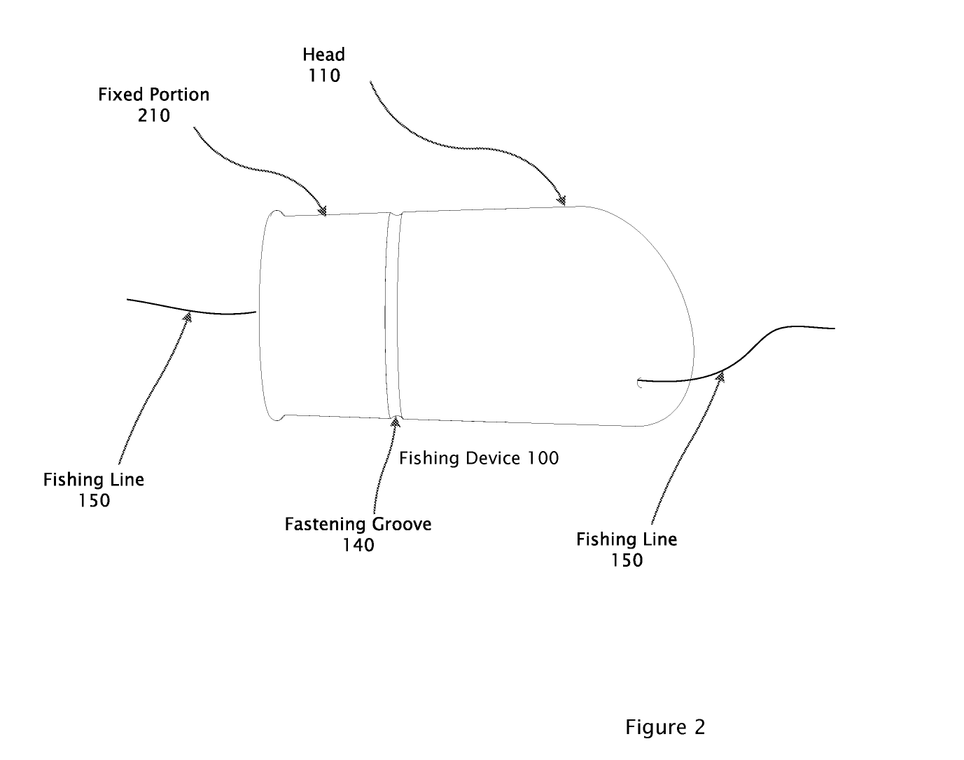

FIG. 2 illustrates the opposite side view of Fishing Device according to the first embodiment. Fixed Portion 210 may be made as one piece with Head 110. Fishing Device 100 may be generally straight, curved, or have a plurality of curves, which may effect a motion while being pulled through water. It may be made of various materials, including, for example, wood, plastic, rubber, metal, or carbon fiber. Fishing Device 100 may be any color, including, for example, colors in the visible light spectrum, ultraviolet colors, or fluorescent colors. It may be used near a hook as a lure, in-line, or in combination with one or more other fishing devices. It may also be used to hold weight, which may eliminate the need for a separate weight on a Fishing Line 150.

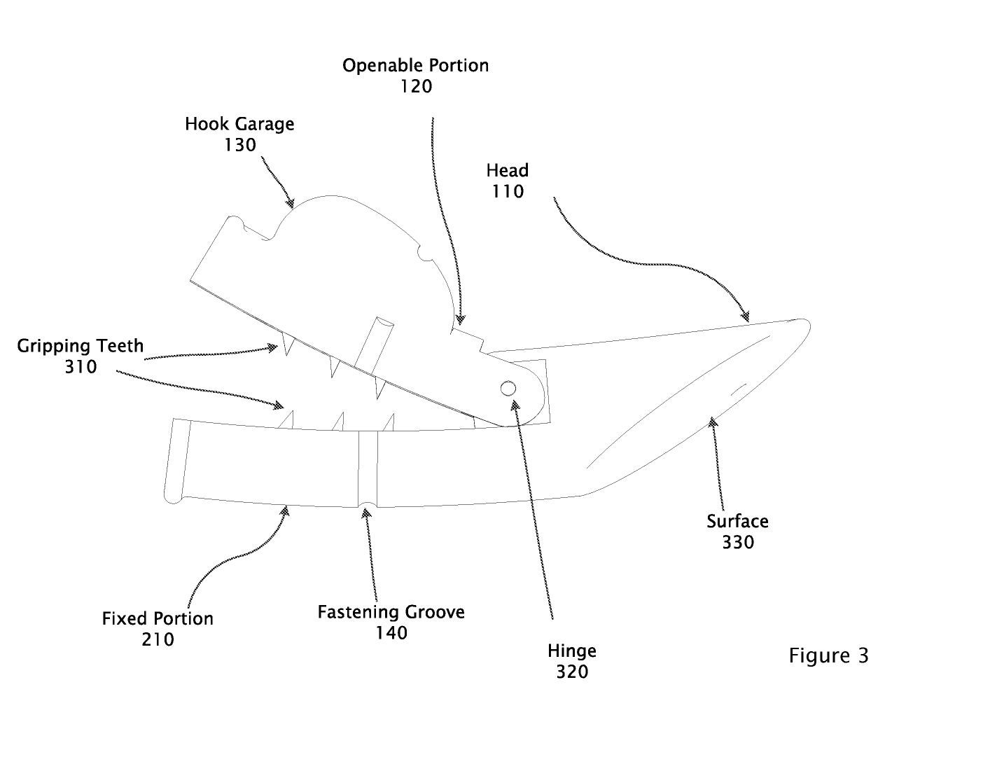

FIG. 3 illustrates Fishing Device 100 with an interior view of Openable Portion 120 opened relative to Fixed Portion 210, each of which may contain a gripping means such as Gripping Teeth 310 to hold bait, such as the body of a fish, in place, for example, if the Fishing Device is moved through water or another medium. A person having skill in the art will recognize that another means besides Gripping Teeth 310 used in this example may be used to hold bait in place.

Openable Portion 120 may couple to Head 110 by a Hinge 320. Hinge 320 may be a hole through Openable Portion 120 and Head 110 with a pin, or may be another hinge means. Openable Portion 120 may also completely separate from Head 110, and be fastened by one or more fastening means, including, but not limited to, elastic bands, surgical tubing, and O-rings. One having ordinary skill in the art will recognize that many different approaches may be used to fasten Openable Portion 120 to Head 110.

Head 110 may generally resemble a cut plug herring head, anchovy head, or any other type of bait head. Surface 330 of the first end of Head 110 may be cut at an angle, which may affect a spiral action or speed of Fishing Device 100 as it moves through the water or another medium.

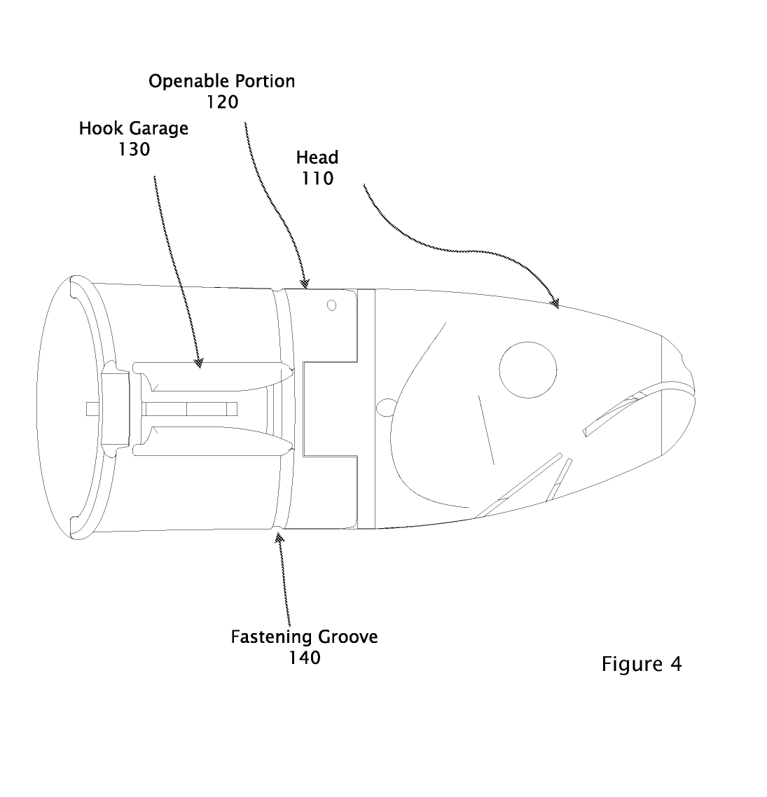

FIG. 4 illustrates a side view of another embodiment. In this embodiment. Head 410 may loosely resemble a fish head. Fishing Device 100 may be generally straight, curved, or have a plurality of curves, which may effect a motion while being pulled through water. It may be made of various materials, including, for example, wood, plastic, rubber, metal. Fishing Device 100 may be any color, including, for example, colors in the visible light spectrum, ultraviolet colors, or fluorescent colors.

One having skill in the art will recognize that many different designs of Fishing Device 100 may fall within the spirit and scope of this disclosure, including, for example, various colors, sizes, and shapes, and Head 110 may be cut at various angles and comprise different types of surfaces.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description may show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data may not provide a complete description of the manufacture and use of the invention. Since many embodiments of the invention can be made without departing from the spirit and scope of the invention, the invention resides in the claims hereinafter appended.

1. A fishing device, comprising:
A head, the head generally resembling a fish head, having a first end and a second end, comprising:
a fixed portion and an openable portion, the openable portion coupled at the first end to the fixed portion by a hinge and coupled at the second end by a first fastening means.

2. The fishing device of claim 1 wherein the openable portion of the head has a gripping means for fixedly attaching bait to the head.

3. The fishing device of claim 2, wherein the gripping means comprises teeth.

4. The fishing device of claim 1 wherein the fishing device is curved along a longitudinal axis.

5. The fishing device of claim 1, wherein the fishing device reflects at least a portion of ultraviolet light to which it is exposed.

6. The fishing device of claim 1, wherein the fishing device has a fluorescent color.

7. The fishing device of claim 1 wherein the fishing device is made from one or more materials selected from the group containing wood, plastic, rubber, metal, and carbon fiber.

8. The fishing device of claim 1 wherein the first fastening means is selected from a group containing a rubber band, an O-ring, and surgical tubing.

9. The fishing device of claim 1 further comprising a hook garage capable of holding a shank of a hook or receiving, guiding, or holding a fishing line or hook, or means for keeping opening portion closed.

10. A fishing device, comprising:
a head, the head generally resembling a cut plug fish head, wherein the front end of the head comprises a surface cut at an angle, having a first end and a second end, comprising:
a fixed portion and an openable portion, the openable portion coupled at the first end to the fixed portion by a hinge and coupled at the second end by a first fastening means; and
a gripping means for fixedly attaching bait to the head.

11. The fishing device of claim 10, wherein the gripping means comprised teeth.

12. The fishing device of claim 10 wherein the fishing device is curved along a longitudinal axis.

13. The fishing device of claim 10, wherein the fishing device reflects at least a portion of ultraviolet light to which it is exposed.

14. The fishing device of claim 10, wherein the fishing device has a fluorescent color.

15. The fishing device of claim 10 wherein the fishing device is made from one or more materials selected from the group containing wood, plastic, rubber, metal, and carbon fiber.

16. The fishing device of claim 10 wherein the first fastening means is selected from a group containing a rubber band, an O-ring, and surgical tubing.

17. The fishing device of claim 10 wherein the fishing device further comprises a hook garage capable of holding a shank of a hook or receiving, guiding, or holding a fishing line or hook, or means for keeping opening portion closed.
